(19) United States
(12) Patent Application Publication
(10) Pub. No.: US 2012/0174209 A1
(43) Pub. Date: Jul. 5, 2012

(54) Method and Device for Detecting Validation of Access Control List

(75) Inventors: Feng Gao, Shenzhen (CN); Jiangwei Li, Shenzhen (CN)

(73) Assignee: ZTE CORPORATION, Shenzhen City, Guangdong Province (CN)

(21) Appl. No.: 13/395,229

(22) PCT Filed: Aug. 25, 2010
(86) PCT No.: PCT/CN10/76326

§ 371 Date: Mar. 9, 2012

(30) Foreign Application Priority Data
Sep. 17, 2009 (CN) 200910092961.9

(51) Int. Cl. G06F 21/00

(52) U.S. Cl. 726/11

(57) ABSTRACT

A method for detecting validation of an Access Control List (ACL) is disclosed in the present invention, when an action part of an ACL rule is performed each time, a counter attached to the currently performed ACL rule is started in accordance with an attachment mode, wherein the counter counts in accordance with a preset counting mode; whether the ACL rule takes effect or not is judged according to whether there is a count value or not by reading the count value stored in the counter. An apparatus for detecting validation of an ACL is also disclosed in the present invention. The apparatus can implement neither increasing the network load nor impacting the safety of a Central Processing Unit (CPU) in a device while judging whether an ACL rule takes effect or not.

### TECHNICAL FIELD

The present invention relates to an access control management technique of service access, and in particular, to a method and apparatus for detecting validation of an access control list.

### BACKGROUND OF THE RELATED ART

Nowadays, the speed of network development is amazing, and network security issues also appear relatively prominent, for a network device (including routers, switches, and so on) carrying a variety of network services, it is particularly important to have its own safety precautions, and the access control list is a good helper.

The function of the Access Control List (ACL) is to filter specific data packets passing through the network device. The ACL classifies the data packets through a series of matching conditions, and these conditions may be source addresses, destination addresses and port numbers of the data packets, and the switch detects the data packets according to the conditions specified in the ACL to decide whether to forward or discard the data packets.

The ACL comprises a port ACL, a global ACL and a VLAN-ACL. The port ACL is an ACL configuring different ACL actions for different ports on the device to implement different control of each port; the global ACL provides users with an ACL configuration mechanism that takes effect at all ports on the whole device; and the VLAN-ACL is an ACL based on a Virtual LAN (VLAN), and the users implements access control of all ports within the VLAN by configuring the VLAN with ACL actions.

Since the ACL plays the role of “firewall” in the network device, whether it can work normally or not and how to judge whether the ACL works normally or not become a key issue.

Generally, an ACL rule in the ACL includes two relatively important parts: a qualify part and an action part.

For example: if an ACL rule which needs to be configured is to discard data packets whose source IP addresses are 10.1.1.1 at port A, then this rule satisfies:

Qualify=port A+source IP 10.1.1.1

Action=discard

When this ACL Rule is configured to port A, the data packets which meet the Qualify condition should be discarded under normal circumstances; however, the network device is often not as simple as we imagine, and sometimes such packets will be normally forwarded rather than discarded. Then, whether the ACL rule does not take effect or although the ACL rule takes effect the forwarding of the packets occurs due to influences of other procedures is required to be judged according to a certain measure.

Thus, judging whether the ACL rule takes effect is a problem required to be solved.

At present, a number of attempts have been made, for example:

A mode is to mirror a data flow to a certain other physical port by modifying the action of the ACL rule to make it perform a port mirror action, and thus, if the mirrored physical port can catch the data flow, it is illustrated that the ACL rule can be normally qualified, that is, the ACL rule takes effect, and if the mirrored physical port cannot catch the data flow, it is illustrated that the ACL rule is not qualified, that is, the ACL rule does not take effect.

Another mode is to try changing the action part of the ACL rule into copying the data flow qualifying the ACL rule to the device's own Central Processing Unit (CPU), that is, changing the Action into copy to CPU, and thus, if the data flow can normally qualify the ACL rule, the CPU is able to receive the data flow, and the data flow can be seen through a CPU's own debugging mode, which means that the ACL rule takes effect; and if the ACL rule is not qualified, the data flow cannot be seen on the CPU, which also means that the ACL rule does not take effect.

These two modes are modes which only diagnose whether the ACL rule takes effect or not in the early stage. Although these two modes can meet the requirements, both are relatively cumbersome. The first method needs the help of other ports, and if all the ports of the network device are used up, this mode cannot be implemented, and in addition, mirroring of ports increases the load of the network device and is not recommended to use in existing network devices; and the second mode is even more dangerous, the CPU of the device is used to process protocol packets and to maintain the device status, and if there are a large number of data packets which are forced to be caught to the CPU, it is likely to lead to the entire device working abnormally.

### SUMMARY OF THE INVENTION

In view of this, the main purpose of the present invention is to provide a method and apparatus for detecting validation of an access control list to effectively judge whether the ACL rule takes effect or not.

In order to achieve the aforementioned purpose, the technical scheme of the present invention is implemented by the following.

The present invention provides a method for detecting validation of an access control list, comprising:

when performing an action part of an ACL rule each time, starting a counter attached to the currently performed ACL rule in accordance with an attachment mode;

the counter counting in accordance with a preset counting mode and storing the count value; and

reading the count value stored in the counter attached to the ACL rule, and if there is a count value, determining that the currently read ACL rule takes effect; otherwise, determining that the currently read ACL rule does not take effect.

In the aforementioned scheme, the attachment mode is a mode of taking starting of a counter as an action in an action part of an ACL rule; or a mode of starting a counter by detecting a result of an action part of an ACL rule.

In the aforementioned scheme, the counting mode is a mode of counting a number of packets or a mode of counting a number of bytes of packets; wherein,

the mode of counting a number of packets is that the count value is automatically added by 1 each time the counter is started;

the mode for counting a number of bytes of packets is that the count value is added by a number of bytes of packets that qualify the currently performed ACL rule at this time when the counter is started each time.

In the aforementioned scheme, the counter is pre-applied in a counter resource pool of a device itself; and the application uses a static application mode or a dynamic application mode to apply; wherein,

in the aforementioned scheme, using the static application mode to apply is applying a counter for each ACL rule in the device, including applying a counter for each empty ACL rule; and

in the aforementioned scheme, using the dynamic application mode to apply is applying a counter for each ACL rule that needs to be detected in the device.

In the aforementioned scheme, after reading the count value stored in the counter, the method further comprises clearing the count value in the counter.

The present invention provides an apparatus for detecting validation of an access control list, comprising: a start-up module, a counter, and a read-out module; wherein

the start-up module is configured to start a counter attached to a currently performed ACL rule in accordance with an attachment mode when performing an action part of an ACL rule each time;

the counter is configured to count in accordance with a preset counting mode and store the count value; and

the read-out module is configured to read the count value stored in the counter attached to the ACL rule, and if there is a count value, determine that the currently read ACL rule takes effect; otherwise, determine that the currently read ACL rule does not take effect.

In the aforementioned scheme, the read-out module is further configured to clear the count value in the counter after reading the count value stored in the counter.

The present invention provides a method and apparatus for detecting validation of an access control list. A counter is attached to an ACL rule in accordance with a certain attachment mode by pre-applying the counter in a counter resource pool of a device itself; when an action part of the ACL rule is performed each time, the counter attached to this ACL rule is started in accordance with the attachment mode, and the counter counts in accordance with a preset counting mode, whether this ACL rule takes effect or not is judged according to whether there is a count value or not by reading the count value stored in the counter, thus implementing neither increasing the network load nor impacting the safety of the CPU of the device while judging whether the ACL rule takes effect or not. In addition, the method for judging whether the ACL rule takes effect or not by checking the count value is relatively simple, and can accelerate positioning a fault in a network.

### BRIEF DESCRIPTION OF DRAWINGS

FIG. 1 is a flow chart for implementing a method for detecting validation of an access control list in accordance with the present invention; and

FIG. 2 is a structural diagram for implementing an apparatus for detecting validation of an access control list in accordance with the present invention.

### PREFERRED EMBODIMENTS OF THE PRESENT INVENTION

The basic idea of the present invention is to pre-apply a counter in a counter resource pool of a device itself, and attach the counter to an ACL rule in accordance with a certain attachment mode; start the counter attached to the currently performed ACL rule in accordance with the attachment mode when an action part of the ACL rule is performed each time, and count by the counter in accordance with a preset counting mode, and judge whether this ACL rule takes effect or not according to whether there is a count value or not by reading the count value stored in the counter.

There are two modes for applying the counter in the counter resource pool of the device itself.

One mode is to apply a counter for each ACL rule in the device, including applying a counter for each empty ACL rule, and this mode is a static application mode, which will take up counter resources of the device, but when a new ACL rule is set for a certain empty ACL rule, there is no need to re-apply a counter.

The other mode is to apply a counter for each ACL rule that needs to be detected in the device, and this mode is a dynamic application mode, which will take up few device resources, but there is a need to apply a counter for each new ACL rule that needs to be detected when a new ACL rule that needs to be detected is set.

Specifically, the attachment mode is a mode of taking starting of a counter as an action in an action part of an ACL rule; or a mode of starting a counter by means such as detecting a result of an action part of an ACL rule.

Said counting mode includes a mode of counting a number of packets or a mode of counting a number of bytes of packets, and so on.

The present invention will be further described in detail in conjunction with accompanying drawings and specific embodiments hereinafter.

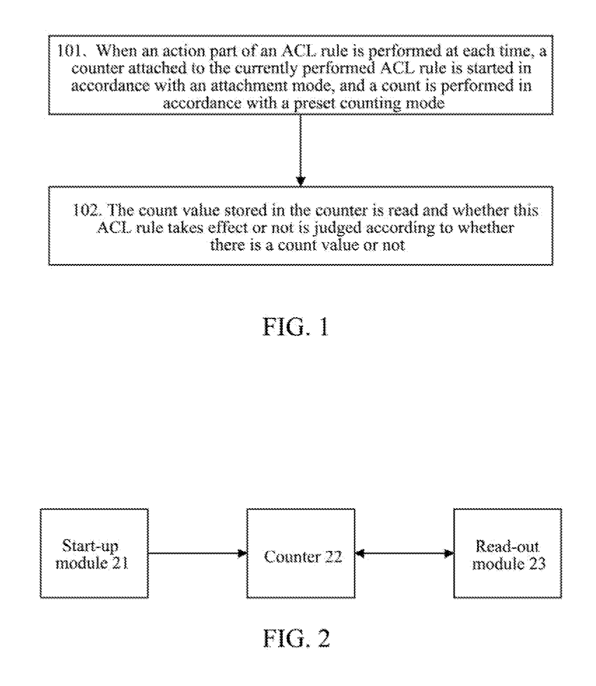

The present invention implements a method for detecting validation of an access control list to pre-apply a counter in the counter resource pool of the device itself and to attach the counter to the ACL rule. As shown in FIG. 1, the method comprises the following steps.

In Step 101, when an action part of an ACL rule is performed each time, a counter attached to a currently performed ACL rule is started in accordance with an attachment mode; a count is performed in accordance with a preset counting mode and a count value is stored.

Specifically, if the attachment mode of attaching the counter to an ACL rule uses the mode of taking starting a counter as an action in an action part of the ACL rule, then when an action part of an ACL rule is performed each time, the counter is started in the action part of the ACL rule, and the counter counts in accordance with the preset counting mode; and if the attachment mode of attaching the counter to an ACL rule uses the mode of starting the counter by detecting a result of an action part of this ACL rule, then when the action part of the ACL rule is performed each time, the result of the action part of the ACL rule is detected, and the counter is started when is the result is detected and the counter counts in accordance with the preset counting mode, and the count value is stored; and when no result is detected, the counter is not started.

In this step, when the preset counting mode is the mode of counting a number of packets, the count value is automatically added by 1 each time the counter is started; and when the preset counting mode is the mode of counting a number of bytes of packets, the count value is added by a number of bytes of the packets that qualify the currently performed ACL rule at this time when the counter is started each time.

In Step 102, the count value stored in the counter is read and whether this ACL rule takes effect or not is judged according to whether there is a count value or not.

Specifically, when there is a need to judge whether an ACL rule takes effect or not, the count value stored in the counter attached to the ACL rule can be read, and if there is a count value, it is determined that the ACL rule takes effect; otherwise, it is determined that the ACL rule does not take effect.

In this step, at the same time of reading the count value stored in the counter attached to the ACL rule, the counter can be further cleared to prevent the count value in the counter from exceeding a maximum value.

Based on the aforementioned method, the present invention implements an apparatus for detecting validation of an access control list. As shown in FIG. 2, the device comprises: a start-up module 21, a counter 22, and a read-out module 23; wherein,

the start-up module 21 is configured to start the counter 22 attached to the currently performed ACL rule in accordance with an attachment mode when an action part of an ACL rule is performed each time.

Specifically, if the attachment mode uses the mode of taking starting of the counter 22 as an action in the action part of the ACL rule, the start-up module 21 is triggered to start the counter 22 in the action part of the ACL rule when an action part of an ACL rule is performed each time; if the attachment mode uses the mode of starting the counter 22 by detecting a result of the action part of this ACL rule, when the action part of this ACL rule is performed each time, the start-up module 21 detects a result of the action part of this ACL rule, and when the result is detected, the counter 22 is started; and when the start-up module 21 does not detect the result, the counter 22 is not started.

The counter 22 is configured to count in accordance with a preset counting mode and store the count value.

Specifically, when the preset counting mode is the mode of counting a number of packets, the count value is automatically added by 1 each time the counter 22 is started; and when the preset counting mode is the mode of counting a number of bytes of packets, the count value is added by a number of bytes of packets that qualify the currently performed ACL rule at this time when the counter 22 is started each time.

The read-out module 23 is configured to read the count value stored in the counter 22 attached to an ACL rule, and if there is a count value, it is determined that the currently read ACL rule takes effect; otherwise, it is determined that the currently read ACL rule does not take effect.

Further, the read-out module 23 is further configured to clear the count value in the counter 22 after reading the count value stored in the counter 22.

In summary, whether the ACL rule takes effect or not can effectively be judged by the method for attaching the counter to the ACL rule, thus implementing neither increasing the network load nor impacting the safety of the CPU of the device while judging whether the ACL rule takes effect or not. In addition, the method for judging whether the ACL rule takes effect or not by checking the count value is relatively simple, and can accelerate the positioning of a fault in a network.

The above description is only the preferred embodiment of the present invention and is not intended to limit the protection scope of the present invention. Any modification, equivalent substitution and improvement made within the spirit and principle of the present invention should be included within the protection scope of the present invention.

What is claimed is:

1. A method for detecting validation of an Access Control List (ACL), comprising:
when performing an action part of an ACL rule each time, starting a counter attached to the currently performed ACL rule in accordance with an attachment mode;
the counter counting in accordance with a preset counting mode and storing a count value; and
reading the count value stored in the counter attached to the ACL rule, and if there is a count value, determining that the currently read ACL rule takes effect; otherwise, determining that the currently read ACL rule does not take effect.

2. The method of claim 1, wherein, the attachment mode is a mode of taking starting a counter as an action in an action part of an ACL rule; or a mode of starting the counter by detecting a result of an action part of an ACL rule.

3. The method of claim 1, wherein, the counting mode is a mode of counting a number of packets or a mode of counting a number of bytes of packets; wherein,
the mode of counting a number of packets is that the count value is automatically added by 1 each time the counter is started;
the mode for counting a number of bytes of packets is that the count value is added by a number of bytes of packets that qualify the currently performed ACL rule at this time when the counter is started each time.

4. The method of claim 1, wherein, the counter is pre-applied in a counter resource pool of a device itself; and the application uses a static application mode or a dynamic application mode to apply; wherein,
said using a static application mode to apply is applying a counter for each ACL rule in the device, including applying a counter for each empty ACL rule; and
said using a dynamic application mode to apply is applying a counter for each ACL rule that needs to be detected in the device.

5. The method of claim 4, wherein, after reading the count value stored in the counter, the method further comprises clearing the count value in the counter.

6. An apparatus for detecting validation of an Access Control List (ACL), comprising: a start-up module, a counter, and a read-out module; wherein
the start-up module is configured to start a counter attached to a currently performed ACL rule in accordance with an attachment mode when performing an action part of an ACL rule each time;
the counter is configured to count in accordance with a preset counting mode and store the count value; and
the read-out module is configured to read the count value stored in the counter attached to the ACL rule, and if there is a count value, determine that the currently read ACL rule takes effect; otherwise, determine that the currently read ACL rule does not take effect.

7. The device of claim 6, wherein, the read-out module is further configured to clear the count value of the counter after reading the count value stored in the counter.

8. The method of claim 2, wherein, the counting mode is a mode of counting a number of packets or a mode of counting a number of bytes of packets; wherein,
the mode of counting a number of packets is that the count value is automatically added by 1 each time the counter is started;
the mode for counting a number of bytes of packets is that the count value is added by a number of bytes of packets that qualify the currently performed ACL rule at this time when the counter is started each time.

9. The method of claim 2, wherein, the counter is pre-applied in a counter resource pool of a device itself; and the application uses a static application mode or a dynamic application mode to apply; wherein,
said using a static application mode to apply is applying a counter for each ACL rule in the device, including applying a counter for each empty ACL rule; and
said using a dynamic application mode to apply is applying a counter for each ACL rule that needs to be detected in the device.
